(19) United States
(12) Patent Application Publication
(10) Pub. No.: US 2004/0177135 A1
(43) Pub. Date: Sep. 9, 2004

(54) Image files constructing tools for cluster configuration

(76) Inventors: Gabriel Monaton, Seyssins (FR); Francois Armand, Noisy Le Roi (FR); Jacques Cerba, Grenoble (FR)

Correspondence Address: WAGNER, MURABITO & HAO LLP, Third Floor, Two North Market Street, San Jose, CA, 95113, US

(21) Appl. No.: 10/676,387

(22) Filed: Sep. 30, 2003

(30) Foreign Application Priority Data
Sep. 30, 2002 (FR) 0212075

(51) Int. Cl. G06F 15/177

(52) U.S. Cl. 709/222; 709/221

(57) ABSTRACT

The image file constructing tool, in accordance with one embodiment of the invention, provides a method of managing a configuration of at least a group of node. The method includes receiving a set of model configuration files. A data model, defining hardware entities and logical entities for a group of nodes, is partially configured as a function of the received model configuration files. The method also includes generating first node data as a function of the partially configured data model. The method also includes installing a specific environment in a machine having at least partially the configuration of the nodes of the group of nodes. The installed specific environment in the machine is utilized to create an archive object using the first node data. The method also includes completing the configuration of the data model dynamically. Second node data is generated as a function of the complete configured data model. The method further includes installing the specific environment in a group of nodes. The specific environment installed in the group of nodes is utilized to create a deployable object from the archive object and the second node data. The specific environment installed in the group of nodes is also utilized to configure the nodes of the group of nodes by deploying the deployable object.

### FIELD OF THE INVENTION

Embodiments of the present invention relate to distributed computer systems, and more particularly to image files constructing tools.

### BACKGROUND OF THE INVENTION

Tools exist for configuring a computer individually, in order for it to run for example a server similar to another computer that runs as a server. Such tools include capture tools and deployment tools. Capture tools enable an administrator to capture the operating systems environment, the application stack and the system configuration of a server and archive such information. Deployment tools utilize the content of the archive generated by the capture tools for the installation of a clone server on a single server. However, such tools do not readily provide a means for the configuration of computer in a distributed computer system.

### SUMMARY OF THE INVENTION

Embodiments of the invention provide an image file constructing tool for cluster configuration. In one embodiment, the image file constructing tool provides a method of managing a configuration of at least a group of node. The method includes receiving a set of model configuration files. A data model, defining hardware entities and logical entities for a group of nodes, is partially configured as a function of the received model configuration files. The method also includes generating first node data as a function of the partially configured data model. The method also includes installing a specific environment in a machine having at least partially the configuration of the nodes of the group of nodes. The installed specific environment in the machine is utilized to create an archive object using the first node data. The method also includes completing the configuration of the data model dynamically. Second node data is generated as a function of the complete configured data model. The method further includes installing the specific environment in a group of nodes. The specific environment installed in the group of nodes is utilized to create a deployable object from the archive object and the second node data. The specific environment installed in the group of nodes is also utilized to configure the nodes of the group of nodes by deploying the deployable object.

Embodiments of the invention enable flash archives to be reproducible and configurable depending on the configuration of a cluster. The flash archives are also reproducible and configurable based upon user defined configuration data. Embodiments of the invention provide for generation and deployment of the flash archives using software management and configuration tools. The software management and configuration tools enable creation and/or utilization of a cluster model, a machine model and a network model. The models are save in a repository Using the different models (cluster, machine and network models) stored in one or more repositories, it is possible to execute the generic flash creation process, the configured flash archive creation process and the flash archive deployment process, each independently by providing consistency checks. Embodiments of the invention further enable a simplification and a standardization of flash archive creation and deployment process for a nodes cluster.

### BRIEF DESCRIPTION OF THE DRAWINGS

The present invention is illustrated by way of example and not by way of limitation, in the figures of the accompanying drawings and in which like reference numerals refer to similar elements and in which:

FIG. 1 shows an exemplary distributed computer system on which embodiments of the invention are implemented.

FIG. 2 shows a block diagram of a group of nodes arranged as a cluster for implementing embodiments of the invention.

FIG. 3 shows a block diagram of a single machine linked to either a machine called a master system at flash archive creation time or a group of running nodes at flash archive deployment time, in accordance with one embodiment of the invention.

FIG. 4 shows a block diagram of a build environment and deployment environment, in accordance with one embodiment of the invention.

FIG. 5 shows a block diagram of inputs used by flash archive creation environment, in accordance with one embodiment of the invention.

FIG. 6 shows a block diagram of the various outputs generated by the flash archive creation environment in accordance with one embodiment of the invention.

FIG. 7 shows a flow diagram of a flash archive creation process, according to one embodiment of the invention.

FIG. 8 shows a flow diagram of an optional configured flash archive creation process, in accordance with one embodiment of the invention.

FIG. 9 shows a flow diagram of a flash archive deployment process, in accordance with one embodiment of the invention.

FIG. 10 shows a classes diagram, in accordance with one embodiment of the invention.

### DETAILED DESCRIPTION OF THE INVENTION

Reference will now be made in detail to the embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it is understood that the present invention may be practiced without these specific details. In other instances, well-known methods, procedures, components, and circuits have not been described in detail as not to unnecessarily obscure aspects of the present invention.

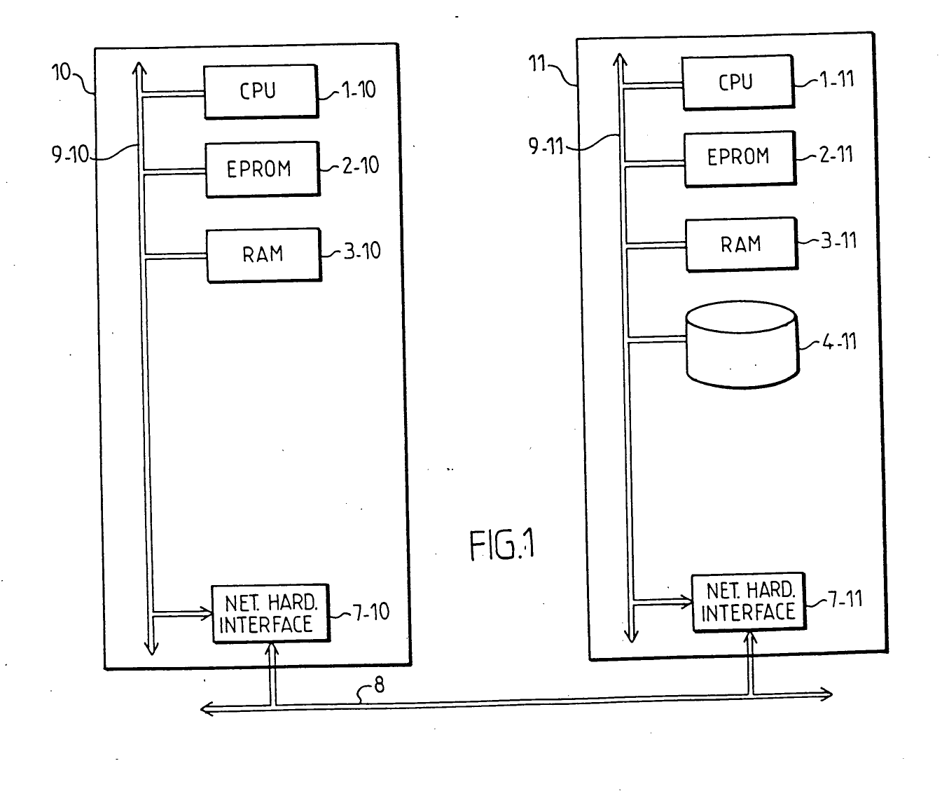

Referring to FIG. 1, an exemplary distributed computer system on which embodiments of the invention are implemented, is shown. As depicted in FIG. 1, the distributed computer system comprises one or more computing devices 10, 11 communicatively coupled by a communication medium (e.g., wire cables, fiber optics, radio-communication or the like) 8. Each computing device 10 includes a processor 1-10 (e.g., Ultra-Sparc), program memory for basic input/output system (e.g., EPROM) 2-10, working memory for software, data and the like (e.g., random access memory of any suitable technology, such as SDRAM) 3-10, and a network interface device (e.g., Ethernet device, a serial line device, an asynchronous transfer mode (ATM) device or the like) 7-10 connected to the communication medium 8. The processor 1-10, program memory 2-10, working memory 3-10 and network interface device 7-10 are communicatively coupled to each other by a system bus 9-10.

The computing device 11 may further include a mass storage device (e.g., one or more hard disks) 4-11. The mass storage device 4-11 is also communicatively coupled to the processor 1-10, program memory 2-10, working memory 3-10 and network interface device 7-10 by the system bus 9-11. It is appreciated that each system bus 9-10, 9-11 may be implemented as one or more buses (e.g., PCI bus, ISA bus, SCSI bus) via appropriate bridges.

Each computing device constitutes a node of the distributed computer system. Nodes 11 having a mass storage device 4-11 are designated as diskfull nodes. Nodes 10 that do not have a mass storage device are designated as diskless nodes.

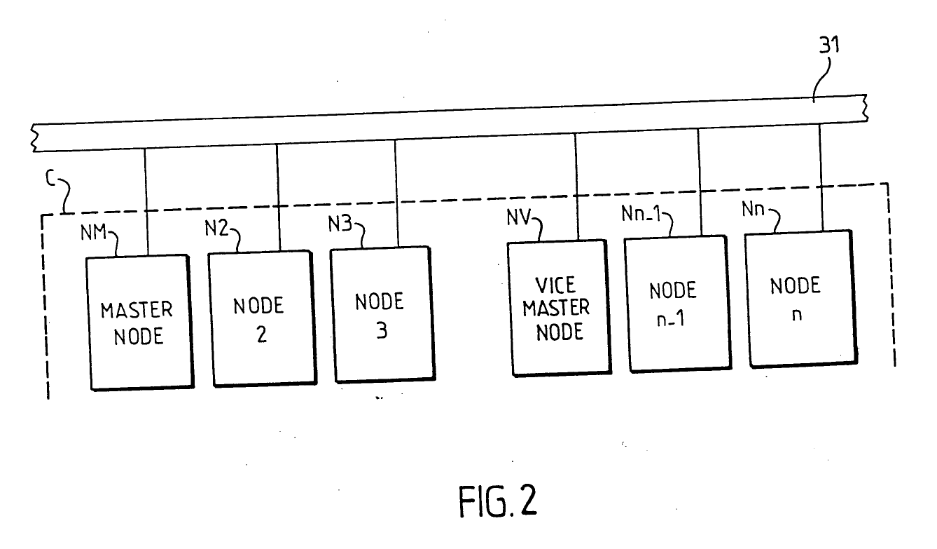

Referring now to FIG. 2, a block diagram of a group of nodes arranged as a cluster for implementing embodiments of the invention, is shown. As depicted in FIG. 2, the cluster C includes a group of master eligible nodes communicatively coupled by a network 31. There may be one or more master eligible nodes in the group of master eligible nodes. A master eligible node may be elected as the master node of the cluster and thus manage the other nodes. The cluster C may optionally include at least a group of non-master eligible nodes.

By way of example only, the cluster C is composed of a group of master eligible nodes having a master node NM, adapted to manage the nodes of the cluster C, and for reliability reasons a vice-master mode NV. The cluster C is also composed of a group of non-master eligible nodes comprising the other nodes N2, N3, . . . Nn−1 and Nn. Each node is connected to the network, which may be redundant. The network 31 is adapted to link nodes of a cluster between them.

It is appreciated that the qualification as a master node NM or as vice-master node NV is dynamic. However, to be eligible as a master node NM or vice-master node NV, a node needs to have the required “master” functionalities. A node being diskfull is considered to have at least partially such master functionalities. One of the nodes in the group of master eligible nodes acts as the master node NM and another one of the nodes in the group of master eligible nodes acts as the vice-master node NV at a given time. Upon failure of the master node NM, the vice-master node NV may replace the failed master node to become the master node.

A diskless node is a node without storage capabilities. Diskless nodes are always non-master eligible nodes. Diskless nodes run/use an operating system, data and software exported by the master node of the cluster. A diskfull node is a node that has storage capabilities. Diskfull nodes can be master eligible nodes or non-master eligible nodes.

A dataless node is a non-master eligible diskfull node. A dataless node shares data and software exported by the master node of the cluster. Contrary to the diskless node, dataless nodes use an operating system stored on a local disk, boots locally and has local storage capabilities.

A nodes group defines a set of nodes that share the role (e.g., master eligible node or non-master eligible node), the operating system, the architecture (e.g., SPARC), the class, the software, the foundation services configuration, and the peripheral capabilities (e.g., same disk capabilities, same I/O card capabilities). Furthermore, every node of a master eligible node group may have the same disk(s) layout(s), the same file systems definitions. The master eligible nodes group (one per cluster) embeds diskless nodes groups environments, if some are defined.

Flash archives are a set of data created with flash tools, which are further described in the following documentation: Solaris 9 Installation guide (ref 806-5205-10). Flash archives (e.g., cluster image) comprise, as known for example, the system image of each node of a cluster. The system image file is a sort of image file (e.g., archive file) that may comprise operating system files, cluster configuration files, user application software and data. When installed on a target machine (e.g., in EPROM or flash memory), the image file is capable (after suitable initialization, such as re-booting) to have the cluster operate consistently in the desired hardware and software configuration. The system image may be replicated (e.g., deployed) on multiple clusters. The flash archive is deployed using replication tools, such as Jumpstart scripts of Sun Microsystems. Jumpstart scripts are further described in the hereinabove cited document, Solaris 9 Installation Guide.

There may be three types of flash archives: generic flash archives, configured flash archive and deployable flash archive. The generic flash archive cannot be deployed. It is a cluster-independent flash archive. The generic flash archive can be used as a basis to generate a deployable flash archive for a set of clusters sharing the topology defined in the cluster image. The configured flash archive is a generic flash archive that embeds user application data and scripts to be installed on the cluster nodes at deployment time. Deployable flash archives are generic or configured flash archives adapted to a specific cluster or a specific site.

A software load (SWL) is a collection of deployable objects (e.g., flash archives dedicated for a specific cluster). The software management and configuration tools, according to embodiments of the invention, is a Sun Microsystems product comprising software tools adapted to configure, build and deploy the SWL on a cluster.

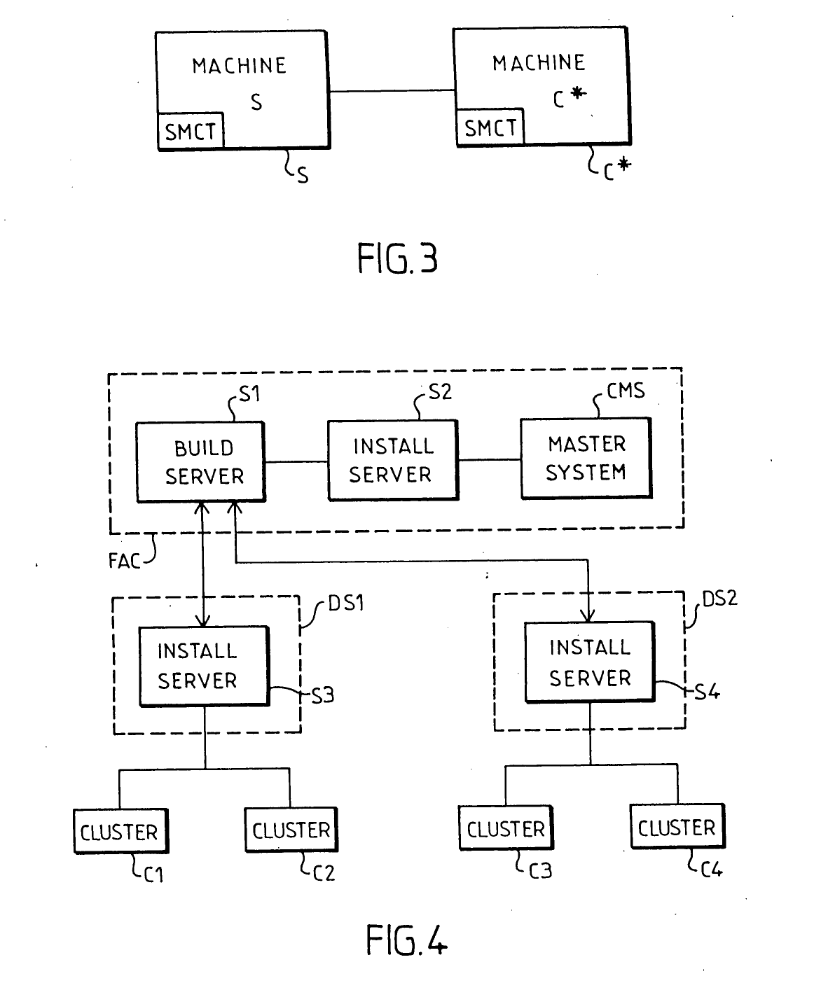

Referring now to FIG. 3, a block diagram of a single machine S linked to a machine that represents either a machine C* called a master system at flash archive creation time (more precisely at software load creation time) or a group of running nodes (e.g., a cluster) at flash archive deployment time (more precisely at software load deployment time), in accordance with one embodiment of the invention, is shown. The single machine runs the software management and configuration tools (SMCT) in accordance with embodiment of the present invention.

The master system (also called a prototype machine) is a machine equivalent to a master eligible node(s) or to a dataless node(s) and from which flash archives and the SWL are built. The master system is a machine comprising the same architecture (e.g., SPARC) and the same disk configuration that the nodes of the group of nodes in the cluster on which the flash archive (more precisely the SWL) is to be deployed.

Referring now to FIG. 4, a block diagram of a build environment and deployment environment, in accordance with one embodiment of the invention, is shown. As depicted in FIG. 4, the build environment and deployment environment includes a flash archive creation environment FAC, one or more flash archive deployment sites DS1, DS2, and one or more clusters C1-C4. The FAC includes a build server S1, an install server S2, and a master system CMS. Each flash archive deployment sites DS1, DS2 includes an install server S3, S4. The SMCT are installed partially on the build server S1 and partially on the install server S2, which are linked to the CMS for flash archive creation. The SMCT are also installed on several install servers S3, S4, which are linked to clusters C1, C2, C3, C4, for flash archive deployment.

The build server S1 may be a machine (e.g., a standard Solaris server) including tools. The tools are adapted to manage software data (e.g., to create the flash archive) and then the SWL (e.g., in preparing the software data). User application data and scripts may also be prepared by the build server S1 in order to be added to flash archives. The build server S1 may work in relation with the install server S2. The install server S2 is a machine used as a host for the environments. The install server S2 includes tools to install a specific environment on a master system CMS and on the nodes of a cluster C1. The install server S2 is used, after installation of a specific environment and gathering of software data by the build server S1, to create the generic flash archives and the software load or to deploy them on the nodes of a nodes group. Configured flash archives may also be created by the install server S2 if user configuration data and scripts are added to the generic flash archives. The software loads may all be in a central repository.

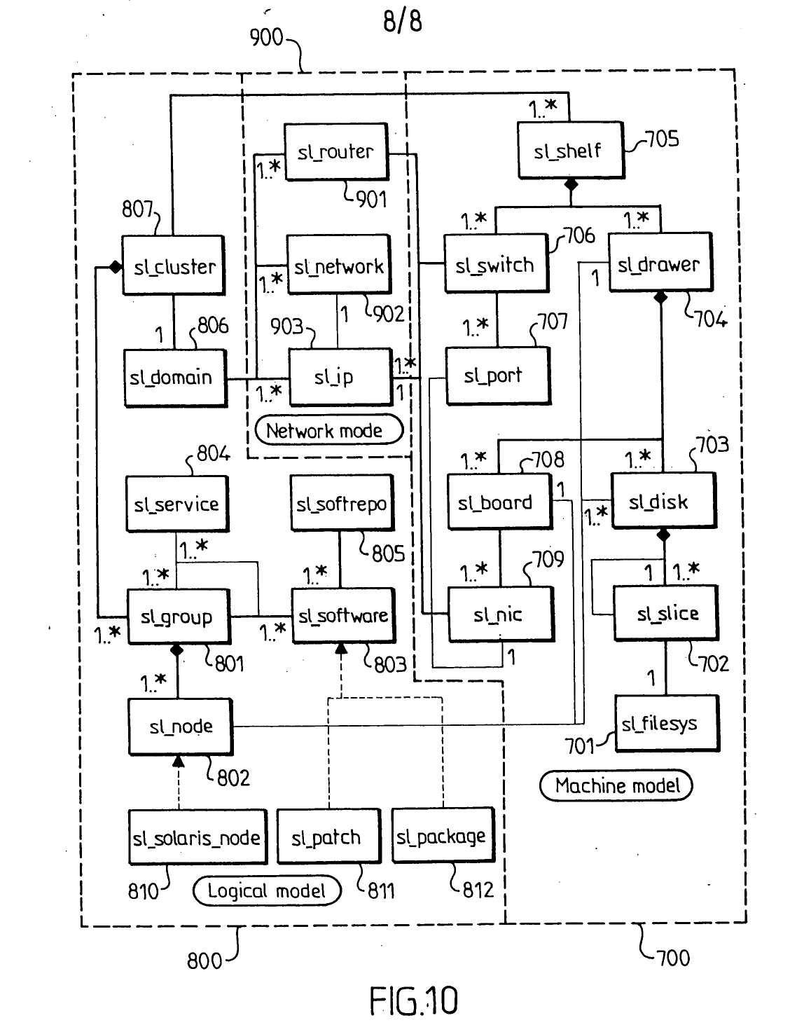

Referring now to FIG. 5, a block diagram of inputs used by flash archive creation environment (e.g., software management and configuration tools) FAC, in accordance with one embodiment of the invention, is shown. As depicted in FIG. 5, the inputs to the FAC include operating system standard tools 100, SMCT configuration data 110, user configuration data 120 and software code 130. It is appreciated that other inputs may also be used. All the inputs 100, 110, 120, 130 to the flash archive creation environment are organized according to a classes diagram, created and configured as described in reference to FIG. 10.

The operating system standard tools 100 comprise for example Sun Microsystems' Jumpstart tools and flash tools. The flash archive creation environment (e.g., software management and configuration tools) user Jumpstart tools for the installation of a specific environment on master systems and cluster nodes. The specific environment on the master system utilizes software data for the flash archive creation. The Jumpstart tools are utilized with the specific environment on the cluster nodes for the deployment and the installation of the flash archives.

The configuration data 110 used by the software management and configuration tools may comprise cluster data, machine data, network data, jumpstart data and nodes group data such as software data and configuration data. The user configuration data 120 includes application configuration data defined by any user and the scripts able to install them on the cluster.

The software code inputs 130 may include various software from different products and user applications (e.g., Sun Microsystems' products). The software code inputs 130 may include several packages and patches (e.g., form Solaris add-on products). For example, some packages and patches come from the Solaris distribution used by Jumpstart.

Referring now to FIG. 10, a classes diagram (e.g., data model), in accordance with one embodiment of the invention, is shown. As depicted in FIG. 10, the classes diagram is adapted to define a cluster model 800, a machine model 700 and a network model 900. Links between the classes represent the relationship between the classes. Thick lines represent containments, fine lines represent references and dotted lines represent inheritances.

The machine model 700 describes all the hardware elements of the cluster and their connections. The cluster topology is thus defined. In the machine model 700, the machine is seen as a hierarchical collection of hardware elements. The outer part of the machine is the shelf (e.g., chassis) 705, the inner part of the machine are the node peripherals (e.g., disk, Ethernet interface NIC and the like). The machine model 700 allows the definitions of several shelves per cluster. Thus, the shelf class 705 contains a switch class 706 and a drawer class 704. The drawer class 704 contains a disk class 703 to define the disk(s) used and a board class 708 to indicate which board is used. The disk class 703 contains the slice class 702 itself containing the file system class 701 to define the file system of a disk slice. The board class 708 contains the Ethernet interface class (NIC class) 709 to define possible multiple Ethernet interface of a board. To define topology of a cluster, the Ethernet interface class 709 is linked to the switch class 706 indicating that an Ethernet interface is linked to a defined switch and more precisely to a defined port of a switch. Indeed, the switch class 706 contains the port class 707. A reference link exists between the port class 707 and the Ethernet interface class 709.

The cluster model 800 describes the cluster nodes and nodes group. It is the logical view of the cluster. The cluster model 800 includes different classes. The cluster class 807 contains the nodes group class 801. The nodes group class 801 themselves contains the nodes class 802. The nodes class 802 inherits an operating system class 810, which may contain any other operating systems (e.g., Solaris) for a node. Each node group class 801 is referred to a software class 803, which defines the software installed for each node of a nodes group. The software class 803 inherits the correction class 811, defining a patch enabling modification of files in a software distribution for a node group. The software class 803 also inherits the installation unit class 812, defining the package for Solaris environment being a software distribution. User defined software distribution, patches and packages may also be defined for other environments in these classes.

Each nodes group of the nodes group class 801 is also referred to a configuration class (not shown). Each configuration class is also referred to as a file class. The configuration class defines user configuration data associated to a nodes group. The file class defines any data file or install scripts of user configuration data associated to a nodes group.

Moreover the software class 803 contains software repository class 805. The software repository class 805 may be used to store the software to be integrated in a flash archive and to define which software of the software repository is adapted to produce a given flash archive for a given nodes group. For the configuration class (not shown), a software repository class (not shown) may comprise the flash archives themselves once created. This last class and software repository class 805 provides a tool for reproducibility of flash archives as described hereinafter.

The node group class 801 is referred to the service class 804. The service class 804 is adapted to provide pre-configured services for the management of a cluster or for the constitution of a cluster (e.g., cluster monitor membership). The cluster class 807 further contains the domain class 806. Each cluster comprises a domain number.

The network model 900 is adapted to configure the IP addressing schema of the network. The network model 900 comprises different classes defining the network. The different classes are linked on one hand to the domain class 806 and on the other hand to the switch class 706 and the Ethernet interface class 709. The different classes comprise the IP address class 903, the network class 902 and the router class 901.

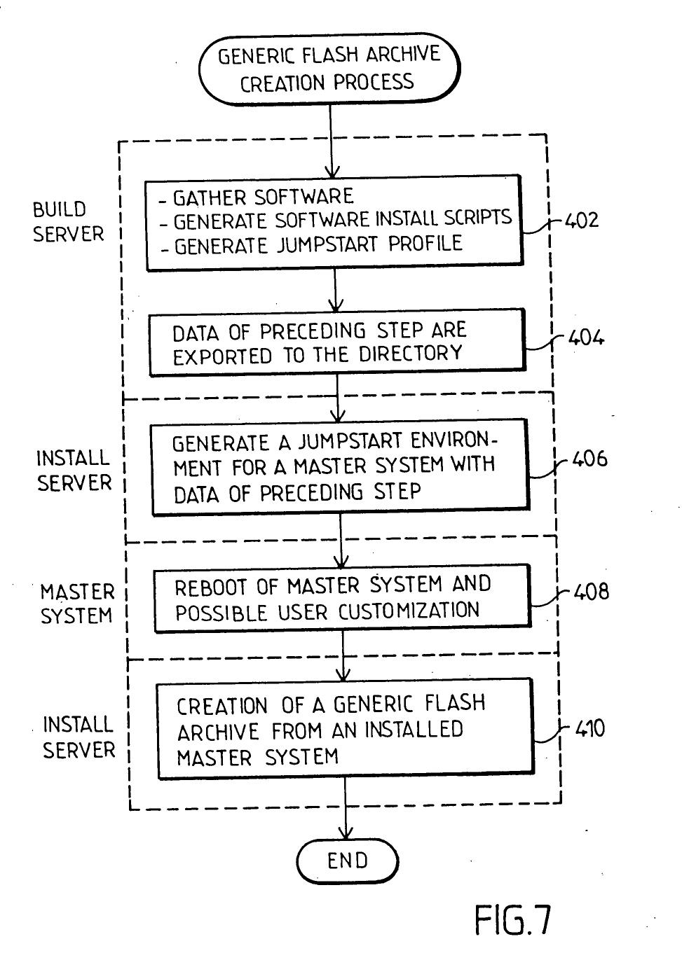

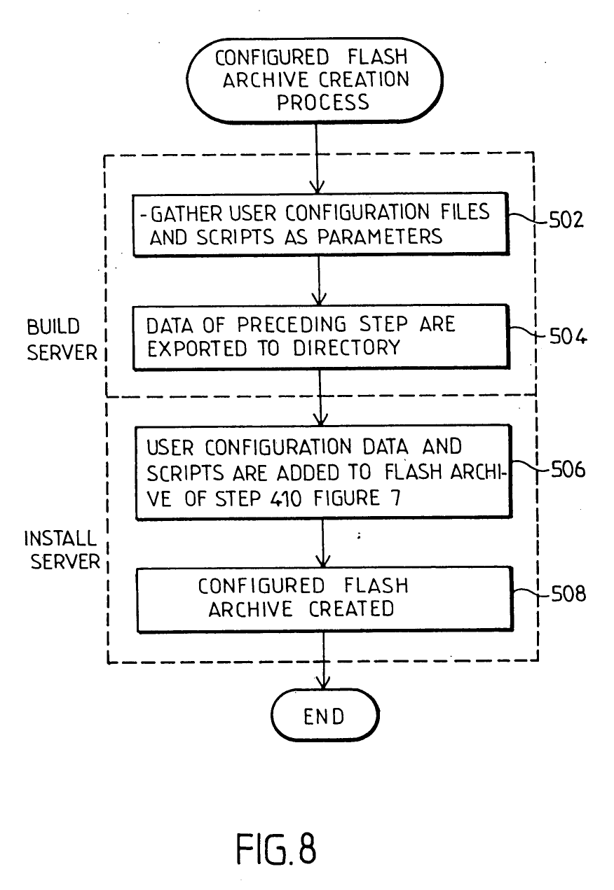

Each of the three models 700, 800, 900 is configured by a configuration file, (e.g., cluster configuration file for the cluster model 800, a machine configuration file for the machine model 700 and a network configuration file for the network model 900). Each configuration file may be fully defined or partially defined, according to the process of FIGS. 7, 8 and 9, by a user.

Some input data may be added or specified in an incremental way. For example, configuration files for the models may be added as input data at flash archive creation or at deployment process, as described in FIGS. 7, 8 and 9. In other words, some input data may be added dynamically according to the process used.

Referring now to FIG. 7, a flow diagram of a flash archive creation process, according to one embodiment of the invention, is shown. The flash archive creation process is managed by the software management and configuration tools (SMCT). The process of flash archive creation is based on a set of configuration files received as inputs by the SMCT. These configuration files include cluster configuration files and machine configuration files. The cluster configuration files include a cluster definition that defines the cluster nodes, the cluster domain, the nodes group and the foundation services associated with each nodes group. The cluster configuration files configures the cluster model of FIG. 10. The machine configuration file defines the machine (e.g., computers) running the cluster. The machine configuration file configures partially, along with the file system definitions, the machine model of FIG. 10.

In addition, the configuration files may also include nodes group configuration files and Jumpstart configuration files. The nodes group configuration file includes software configuration files for foundation services (e.g., packages and patches) that rely on predefined configuration files, and optionally user defined software. The Jumpstart configuration file defines a Jumpstart profile for each diskfull node. The Jumpstart profile defines the operating system standard tools or packages for Solaris to install on such nodes.

As depicted in FIG. 7, the build server is adapter, from the input configuration files and for each nodes group, to gather the software, to generate software install scripts and to generate a Jumpstart profile for master eligible and dataless nodes groups, at 402. The build server also generates a software load descriptor. At 404, the node data generated is copied into a directory.

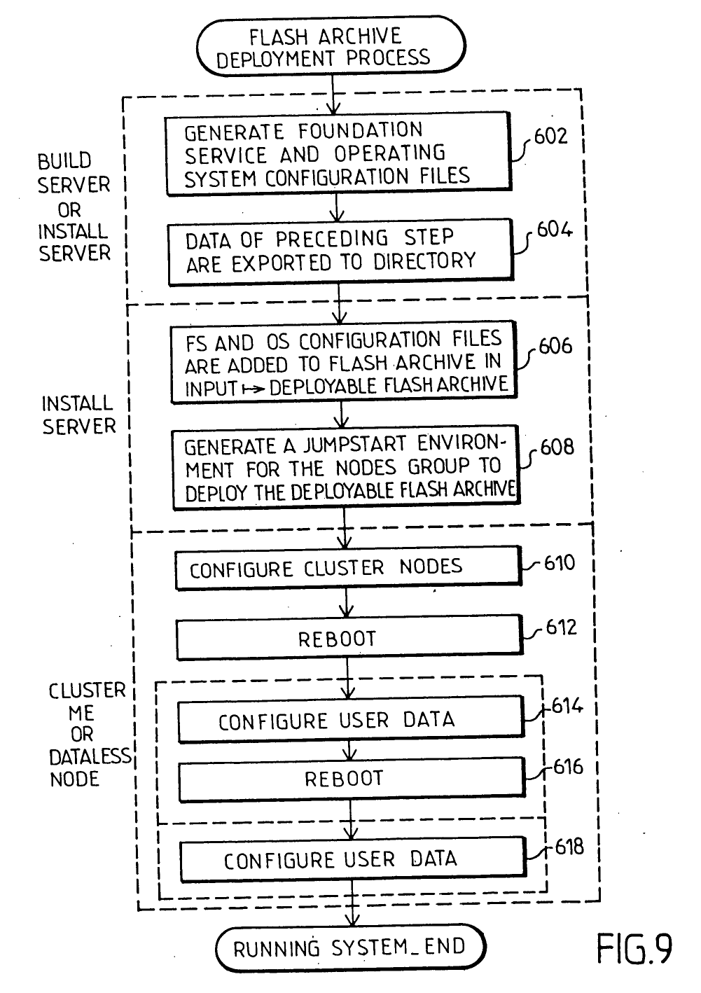

At 406, the install server is adapted to generate a Jumpstart installation environment for a master system from the node data in the directory. The operation is run once per group, each nodes group is processed individually. Each master system has the software data of the nodes group targeted. Once the Jumpstart installation is finished, the master system reboots and the user may perform any customization, at 408. At 410, the install server generates a generic flash archive from the installed master system. The generic flash archive created may comprise two sections, one binary and one ASCII. The binary section corresponds to the system image (e.g., the ‘archive files’ section of the flash archive). The ASCII section holds the signature of the software load descriptor generated at operation 402. The signature enables one to identify the flash archives in order to perform consistency checks, in the processes described in FIGS. 8 and 9, to describe the content of the flash archive and to interrogate and/or display the content of the flash archives. The software load may also be created at this time.

Though the above-described operation are processed, as indicated in FIG. 7, in the different servers (e.g., build server and install server), the operation may be processed in a single server having the software management and configuration tools (SMCT).

Referring now to FIG. 8, a flow diagram of an optional configured flash archive creation process, in accordance with one embodiment of the invention, is shown. The flash archive configuration includes adding or replacing configuration data sections to an existing flash archive. The configured flash archive creation is based on the following inputs received by the software management and configuration tools. A flash archive (e.g., generated according to the process of FIG. 7 or already configured according to the process of FIG. 8) stored in the central repository. User data given as a set of files called user defined configuration files, wherein the user data is being added in the configuration class of the cluster model. Installation scripts for the user data, wherein the scripts are being added in the file class of the cluster model. The control of the order of the scripts execution and the configuration of data and scripts are allowed by user defined configuration files.

As depicted in FIG. 8, the build server is adapted to gather user defined configuration data (e.g., a set of files) and user defined configuration data installation scripts given as parameters, at 502. The scripts and data are configured at deployment time, as described with reference to FIG. 9. The scripts are aimed at installing the user data at deployment time. In one implementation, all the nodes groups are processed in one operation. At 504, the data generated is copied into a directory. The data generated is also exported as they are in the directory. At 506, ASCII sections are generated from the user defined data. A single section may include all the nodes in the nodes group configuration data and scripts. If a flash archive is given as input (e.g., a generic flash archive from 410 of FIG. 7, or an already configured flash device), the configuration sections are replaced by the new one. The operation runs once per nodes group (e.g., each nodes group is processed individually).

Configured flash archives are thus created at 508. The configured flash archives may be stored in the central repository for reproducibility of the deployment process, as described with respect of FIG. 9. All the data inputs and operation 502 are optional. If none of these data inputs exist, no new sections are created or replaced. The configuration data and scripts are configured at the nodes group level so that the associated flash archives can be configured.

Referring now to FIG. 9, a flow diagram of a flash archive deployment process, in accordance with one embodiment of the invention, is shown. The flash archive deployment process is managed by the software management and configuration tools (SMCT). The install server and the build server are linked to the nodes group on which the flash archives are to be deployed. The input data for the flash archive deployment process includes the flash archives, as described with respect to FIGS. 7 and 8, and the configuration data. The input data also includes the configuration files, as described with respect to FIG. 10. The configuration files include a cluster configuration file being logical cluster definition that defines cluster nodes, nodes groups and foundation service list. The foundation services include the different services that a node in a cluster may need (e.g., Reliable Boot Service (RBS), Cluster Membership Monitor (CMM), and the like). The configuration files also include a machine configuration file that defines the machine running the cluster and a network configuration file that defines the network parameters needed by the cluster.

Different consistency checks are accomplished with regard to the foundation services to configure. Configuration data may be imported from the flash archive configuration process as an input (e.g., from the software repository class). For a configured flash archive, the configuration data may indicate when to run the user install scripts for applications as described hereinafter.

As depicted in FIG. 9, the build server generates the foundation services configuration files and the operating system configuration files according to the input being a cluster, machine and network configuration files of the data model, at 602. The foundation services configuration files are, for example, network configuration files or DHCP configuration files. The operation may be run once per software load (e.g., all the nodes groups are processed in one operation). A consistency check may be done with imported configuration data. At 604, the foundation services configuration files are exported (e.g., copied) into a directory.

At 606, the install server adds sections to the flash archive that includes the exported data copied to the directory. The software load descriptor stored in the software load section, as described with respect to FIG. 7, is replaced in order to take into account the complete cluster definition. The flash archives are now deployable flash archives. Another consistency check may be done using the archive and the software load data.

At 608, the install server generates a Jumpstart environment for each node of the nodes group given as parameters (e.g., each nodes group may be processed individually). The install server then deploys the flash archives in the form of a software load, in each node of the nodes groups.

At 610, the nodes of the cluster are configured using the deployable flash archives. If the flash archive defines no user configuration data and scripts, the process continues with a reboot of the nodes of the nodes group at 612, optional operations 614, 616 and 618 (surrounded by dotted lines) are not performed and the process ends with the run of the cluster.

If the flash archives define user configuration data and scripts, the optional operations may be executed according to the following cases. A second reboot may have been configured. In such as case, the foundation services (e.g., cluster service) are not started yet. The user configuration data is configured at 614 and the second reboot starts the foundation services at 616. The process may then configure other user configuration data at 618 and ends with the run of the cluster, or may directly end with the run of the cluster. Alternatively, the reboot at 612 has started the foundation service and the user configuration data are configured at 618. The process may then end with the run of the cluster.

Configuration data in the configuration class of FIG. 10 is used to indicate at which operation to run the user install scripts. The double reboot operation is used to configure any kind of nodes group (e.g., master eligible group of nodes or dataless group of nodes of a cluster) using user configuration data. To take into account cluster dependent data, the configured flash archive creation process described with reference to FIG. 8 may be run again to change the content of the configuration data actions in the flash archives.

The first set of tools used to prepare the final configuration data may be in the build server or in the install server connected to the cluster. The second set of tools used to incorporation the configuration data into the flash archives and creating the cluster Jumpstart deployment environment may be in the install server. The final configuration data can be merged into a centralized software load repository. To communicate the software load data between the different environments, import and export operations are used.

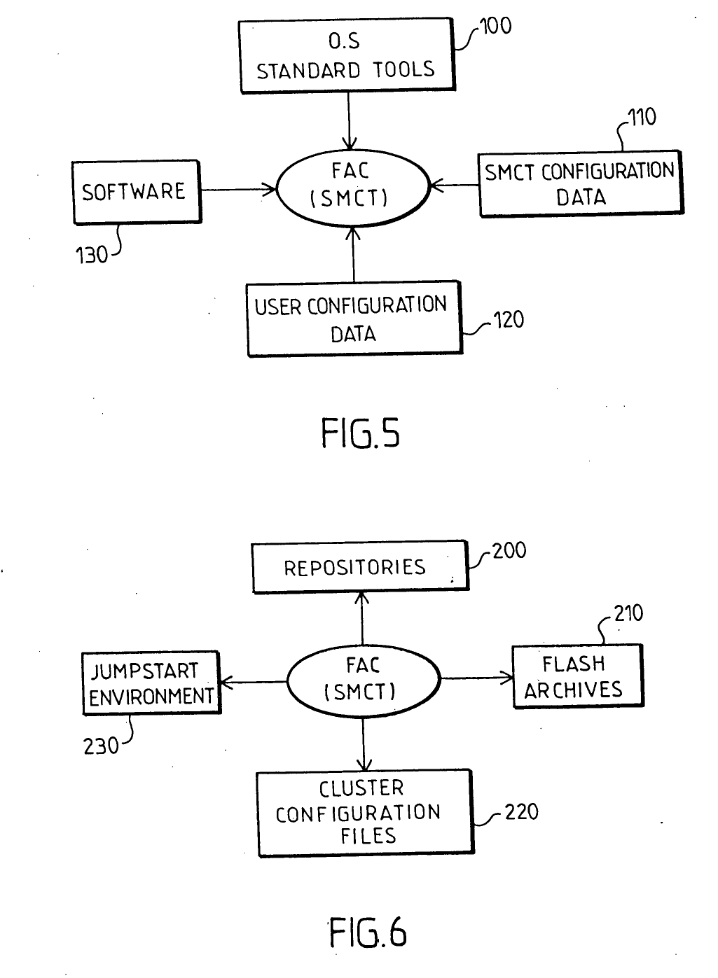

Referring now to FIG. 6, a block diagram of the various outputs generated by the flash archive creation environment (e.g., software management and configuration tools) FAC, in accordance with one embodiment of the invention, is shown. The FAC implements the generic flash creation process, the configured flash archive creation process and the flash archive deployment process, as described with respect to FIGS. 7, 8 and 9 respectively. As depicted in FIG. 6, the outputs of the FAC include repositories 200, the flash archives 210, the cluster configuration files 220 and the Jumpstart environment 230. The flash archives 210 are the main outputs of the software management and configuration tools (SMCT). The flash archives 210 may be a self-describing deployment object. At least three types of flash archives per software load are managed by the SMCT. Repositories 200, such as software repository and software load repository, enable rebuilding an identical or similar flash archive with stored data if needed (e.g., if a flash archive is destroyed). The master systems Jumpstart environment and the cluster nodes Jumpstart environment or other environment 230 are adapted to provide tools to deploy flash archive. The cluster configuration files 220 include foundation services configuration files and operating system configuration files.

Embodiments of the present invention enable flash archives to be reproducible and configurable depending on cluster configuration and/or user defined configuration data. Flash archives are thus generated and deployed using the software management and configuration tools. Using the different models (cluster, machine and network models) having repositories, it is possible to execute the generic flash creation process, the configured flash archive creation process and the flash archive deployment process, each independently by providing consistency checks. Embodiments of the invention further enable a simplification and a standardization of flash archive creation and deployment process for a nodes cluster.

The invention is not limited to the hereinabove embodiments. Other environments may be used. Some operations may also be used for supplementary configurations. Thus, the double reboot operations, as described with reference to FIG. 9, may also be used to manage internally the configuration of some services. For example, for a given service if the configuration is done during the cluster configuration and if this service is required (e.g., another service is missing) the double reboot operation enables one to configure the given service on the nodes of the node group.

Embodiments of the invention also cover the software code for performing the generic flash creation process, the configured flash archive creation process and the flash archive deployment processes, as described with reference to FIGS. 7, 8 and 9. Especially when made available on any appropriate computer-readable medium. The expression “computer-readable medium” includes a storage medium such as magnetic or optic, as well as a transmission medium such as a digital or analog signal. The software code basically includes, separately or together, the codes defining the build server, the install server and the master system.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A computer-readable medium containing code which when executed causes a network device to implement a method of managing a configuration of at least a group of nodes comprising:
an input code, capable of receiving a set of model configuration files adapted to create and configure at least partially a data model, wherein said data model defines hardware entities and logical entities for a group of nodes;
a generator code, capable of generating a first node data in cooperation with said at least partially configured data model;
an install code, capable of installing a specific environment in a machine having at least partially the configuration of the nodes of the group in order to create an archive object using said first node data;
configuration code, enabling a user to complete the configuration of said data model dynamically and generate a second node data; and
said install code, further capable of installing a specific environment in said group of nodes in order to create a deployable object from said archive object and said second node data and to configure nodes of said group of nodes in deploying said deployable object.

2. The computer-readable medium according to claim 1, wherein said second node data is stored in a repository enabling the re-creation of a deployable object.

3. The computer-readable medium according to claim 2, wherein said second node data comprises operating system files and service configuration files for said group of nodes.

4. The computer-readable medium according to claim 1, wherein said first node data is stored in a repository enabling the re-creation of said archive object.

5. The computer-readable medium according to claim 4, wherein said second node data is stored in said repository enabling the re-creation of said archive object and said deployable object.

6. The computer-readable medium according to claim 4, wherein said first node data comprises software data and a software install script for said group of nodes.

7. The computer-readable medium according to claim 6, wherein said install code is further adapted to create a configured archive object in adding user defined configuration data and user install scripts to said archive object.

8. The computer-readable medium according to claim 7, wherein said install code is further adapted to create a new configured object in adding new user defined configuration data and new user install scripts to an already configured archive object.

9. The computer-readable medium according to claim 7, wherein said install code is further adapted to configure nodes of said group of nodes, to reboot said nodes, to configure said user defined configuration data and to run said nodes.

10. The computer-readable medium according to claim 7, wherein said install code is further adapted to configure nodes of said group of nodes, to perform a first reboot of said nodes, to configure said user defined configuration data, to perform a second reboot of said nodes and to run said nodes.

11. The computer-readable medium according to claim 1, wherein said input code is further adapted to receive said set of model configuration files comprising a logical configuration file for said group of nodes and a hardware configuration file, and is further adapted to receive a network configuration file in order to complete said data model.

12. The computer-readable medium according to claim 1, wherein said data model as at least partially configured comprises a hardware model linked to a logical model for said group of nodes.

13. The computer-readable medium according to claim 1, wherein the completed data model comprises a hardware model linked to a logical model for said group of nodes and to a network model.

14. The computer-readable medium according to claim 1, wherein said data model is organized in classes.

15. The computer-readable medium according to claim 1, wherein said machine is a prototype machine having at least partially said configuration of nodes of said group of nodes for which an archive object is created.

16. The computer-readable medium according to claim 1, wherein said deployable object is a deployable flash archive.

17. The computer-readable medium according to claim 1, wherein said archive object is a flash archive.

18. A method of managing a configuration of at least a group of nodes comprising:
receiving a set of model configuration files;
configuring at least partially a data model as a function of said model configuration files, wherein said data model defines hardware entities and logical entities for said group of nodes;
generating a first node data as a function of said at least partially configured data model;
installing a specific environment in a machine having at least partially the configuration of said group of nodes in order to create an archive object using said first node data;
completing the configuration of said data model dynamically and generate a second node data; and
installing said specific environment in said group of nodes in order to create a deployable object from said archive object and said second node data and in order to configure the nodes of said group of nodes in deploying said deployable object.

19. The method according to claim 18, wherein said first node data is stored in a repository enabling the recreation of said archive object.

20. The method according to claim 19, wherein said first node data comprises software data and a software install script for said group of nodes.

21. The method according to claim 19, wherein said second node data is store in said repository enabling recreation of said deployable object.

22. The method according to claim 20, wherein said second node data comprises operating system files and service configuration files for said group of nodes.

23. The method according to claim 18, wherein said installing said specific environment in said machine having at least partially the configuration of said group of nodes further comprises a configured archive object by adding user defined configuration data and user install script to said archive object, said configured archive object being used to create said deployable object.

24. The method according to claim 23, wherein said installing said specific environment in said machine having at least partially the configuration of said group of nodes further comprises creating a new configured object by adding new user defined configuration data and new user install scripts to said already configured archive object.

25. The method according to claim 23, wherein installing said specific environment in said group of nodes further comprises configuring nodes of said group of nodes, rebooting said nodes, configuring said user defined configuration data and running said nodes.

26. The method according to claim 23, wherein installing said specific environment in said group of nodes further comprises configuring nodes of said group of nodes, performing a first reboot of said nodes, configuring said user defined configuration data, performing a second reboot of said nodes and running said nodes.

27. The method according to claim 18, wherein said set of model configuration files comprises a logical configuration file for said group of nodes and a hardware configuration file.

28. The method according to claim 27, further comprising:
receiving a network configuration file; and
completing configuration said data model as a function of said network configuration file.

29. The method according to claim 18, wherein said at least partially configured said data model comprises a hardware model linked to a logical model for said group of nodes.

30. The method according to claim 18, wherein said completed data model comprises a hardware model linked to a logical model for said group of nodes and to a network model.

31. The method according to claim 18, wherein said data model is organized in classes.

32. The method according to claim 18, wherein said machine is a prototype machine having at least partially the configuration of nodes of said group of nodes for which an archive object is created.

33. The method according to claim 18, wherein said deployable object is a deployable flash archive.

34. The method according to claim 18, wherein said archive object is a flash archive.
